(19) United States
(12) Patent Application Publication
(10) Pub. No.: US 2021/0409216 A1
(43) Pub. Date: Dec. 30, 2021

(54) SYSTEM AND METHOD FOR PROVIDING CONTROLLED ACCESS TO PERSONAL INFORMATION

(71) Applicant: Markaaz, Inc., Austin, TX (US)

(72) Inventor: Hany FAM, Newport (GB)

(21) Appl. No.: 17/362,059

(22) Filed: Jun. 29, 2021

Related U.S. Application Data
(60) Provisional application No. 63/045,729, filed on Jun. 29, 2020.

(51) Int. Cl. H04L 9/32; H04L 9/30; H04L 9/08; G06Q 20/38; G06Q 20/40; G06F 16/23

(52) U.S. Cl. CPC H04L 9/32; H04L 9/30; H04L 9/0866; G06Q 20/389; G06Q 30/0185; G06Q 20/3829; G06F 16/2379; H04L 2209/38; G06Q 20/4014

(57) ABSTRACT

Systems and methods for managing verification and identity information comprises a private blockchain configured to be accessed by a user associated with a first entity. The private blockchain comprises an immutable ledger. Information associated with the first entity is stored on the private blockchain. A digital passport is generated containing blocks corresponding to the private blockchain that are associated with the first entity. The user causes to be transmitted attestation information verifying that the user is associated with the first entity.

### CROSS REFERENCE TO RELATED APPLICATION

The present application is a nonprovisional patent application, which claims the priority benefit of U.S. application Ser. No. 63/045,729, filed Jun. 29, 2020, the text and drawings of which are hereby incorporated in its entirety.

### TECHNICAL FIELD

This disclosure relates generally to the field of electronic commerce technology. In particular, it relates to a system and method for managing verification and identity information.

### BACKGROUND

The process of choosing the right supply chain vendors to work with can be challenging for users and administrators associated with entities, such as business owners and managers. Aside from performing search to identify vendors with the capacity to provide supply as needed, and at a competitive price point, the user must also frequently to perform complex due-diligence and time-consuming processes to confirm that those suppliers are who they claim to be.

A supplier verification system is required to reduce risk exposure from fraudulent vendors, suppliers that are insolvent, unable to keep up with demand or who do not comply with safety standards or other regulatory requirements. Supplier verification is one of the first steps your business takes toward earning a profit. A business may have a great idea for a novel product and organize an efficient team to manufacture the product, market it to consumers, fulfill orders, and provide exemplary customer service. However, the requirement of maintaining reliable vendor relationships is essential to facilitate the creation of that product in the first place. However, prior approaches do not provide an easy, user-friendly way to perform such due diligence or to access a community of reliable suppliers. The presently disclosed embodiments offer improvements to these prior approaches.

### SUMMARY

The present disclosure relates to a system and method for managing verification and identity information. In at least one embodiment, the system for vendor verification comprises a passport to enable secure access to a community of entities, such as businesses and institutions. A user associated with an entity, such as a business or institution, can be enabled by the system to pay and be paid utilizing the passport. The passport operates as a single source of verified information, permitting data provenance corresponding to information publicly available about the entity. Additionally, the passport enables the user to store important non-public information, secured and shared only as intended by the user.

According to some embodiments, a system for managing entity identity information, the system comprising a processor; and a memory coupled with the processor, wherein the system is configurable to form and operate a private blockchain comprising an immutable ledger. The system stores information a first entity on the private blockchain and generates a digital passport associated with the first entity.

Based upon a request of a user associated with the first entity, the system is configurable to provide access to the digital passport to the user, permitting the user to add information, such as verification and identity information, in the form of blocks added to the private blockchain. In some aspects, the system or a host of the system can restrict access to the digital passport to be solely administered by the user.

According to an embodiment, the system generates a first record comprising identity information associated with a first entity. The user associated with the first entity is enabled to transmit (or cause to be transmitted from a third party) first attestation information. In some aspects, the first attestation information can comprise information and/or documentation verifying that the user is associated with the first identity. The system can generate a first key and a second key associated with the digital passport of the first entity.

According to some embodiments, the system configures a stamp data structure associated with the first entity in a record of the digital passport. The stamp data structure can include information associated with the first entity. In some embodiments, a stamp can include information about one or more of: ownership information, identity information, an employer identification number (EIN), know your business (KYB) information, know your customer (KYC) information, and credit information. In some embodiments, the stamp data structure can include the information associated with the first entity and verification information associated with the authenticity of the information.

According to some embodiments, the system can be configurable to transmit second attestation information to the user, the second attestation information including verification associated with a second entity. In some non-limiting examples, the first entity can be an asset requester and the second entity can be an asset provider. Based upon a request by the user associated with the first entity, the system can be configurable to transmit a secure communication of the first key (e.g., a public key) from the user to the second entity, create an asset instance based on the public key, and share the asset instance with the first entity, wherein the user is enabled to access the asset instance utilizing the second key. In some non-limiting examples, the system transmits a transaction record associated with the asset on the immutable ledger of the private blockchain.

According to an embodiment the passport digitizes a user's information and saves it on a secure blockchain, which puts it in the user's possession, meaning the user is the sole owner. And the passport holds a number of digital stamps giving the user access to various places and services.

The passport acts like the user's secure key to institutions that typically need verified business information before the user can transact, like applying for credit or taking out a new lease or verifying suppliers.

The passport collates and saves digital stamps that allow incremental levels of identity verification. When a user needs to transact, the institution with your permission, can call on the user's passport to acquire the stamps required via a secure token. Verification is done instantly, removing the need for the usual paperwork and hassle.

The process of providing authenticated identity and verification information between entities can be challenging, especially for small business owners and managers. The system and method for managing verification and identity information enables users to access and transact with suppliers while reducing risk exposure associated with fraudulent vendors, failing vendors, or existing vendors that fail to comply with high demand, safety standards and other regulatory and non-regulatory requirements

### DESCRIPTION OF DRAWINGS

FIG. 1 depicts an environment of a system for managing verification and identity information, according to an embodiment of the present disclosure.

FIG. 2 is a schematic diagram of a system for managing verification and identity information, according to an embodiment of the present disclosure.

FIG. 3 is a schematic diagram of a system for managing verification and identity information, according to an embodiment of the present disclosure.

FIG. 4 is a schematic flowchart of a method for a system for managing verification and identity information, according to an embodiment of the present disclosure.

FIGS. 5A to 5I depict a user interface, according to an embodiment of the present disclosure.

FIG. 6 is a schematic diagram of a system for including an AI platform for creating dynamic groups, according to an embodiment of the present disclosure.

FIG. 7 is a schematic flowchart of a method for using an AI platform for creating dynamic groups, according to an embodiment of the present disclosure.

### DETAILED DESCRIPTION

For the purposes of managing verification and identification information, according to the principles of the present disclosure, reference will now be made to the embodiments illustrated in the drawings, and specific language will be used to describe the same. It will nevertheless be understood that no limitation of the scope of this disclosure is thereby intended.

The presently disclosed embodiments utilize a system for vendor verification that includes a digital passport to enable secure access to a community. A user associated with an entity, such as a business or institution can access the system to pay and be paid utilizing the passport. The passport operates as a single source of verified information, permitting data provenance corresponding to information publicly available about the entity. Additionally, the passport enables the user to store important non-public information, secured and shared only as intended by the user.

Based upon a request of a user, the system provides access to the digital passport to the user, permitting the user to add information, such as verification and identity information, in the form of blocks added to the private blockchain. The user associated with a business or institution is enabled to transmit (or cause to be transmitted from a third party) attestation information that verifies the relationship of the user to the entity and authenticates information associated with the entity. The attestation information can include information and/or documentation verifying that the user is associated with the first identity. The system can generate and provide to the user a public key and a private key associated with the digital passport of the entity.

According to some embodiments, the system configures a stamp data structure associated with the first entity in a record of the digital passport. The stamp data structure can include information associated with the first entity. In some embodiments, a stamp can include information about one or more of: ownership information, identity information, an employer identification number (EIN), know your business (KYB) information, know your customer (KYC) information, and credit information.

For example, KYB information can be information generated based on business due diligence to identify and verify the identity of a business. Such information can include identity information of legal representatives of a business and verification of their connection with the business.

In another non-limiting example, KYC information can be information generated based on customer due diligence to identify and verify the identity of a customer. Such information can include verification of an individual's name, date of birth, address and social security number, or the like.

In some embodiments, the stamp data structure can include the information associated with the first entity and verification information associated with the authenticity of the information. The stamp data structures can be shared between digital passports of the user and a second institution.

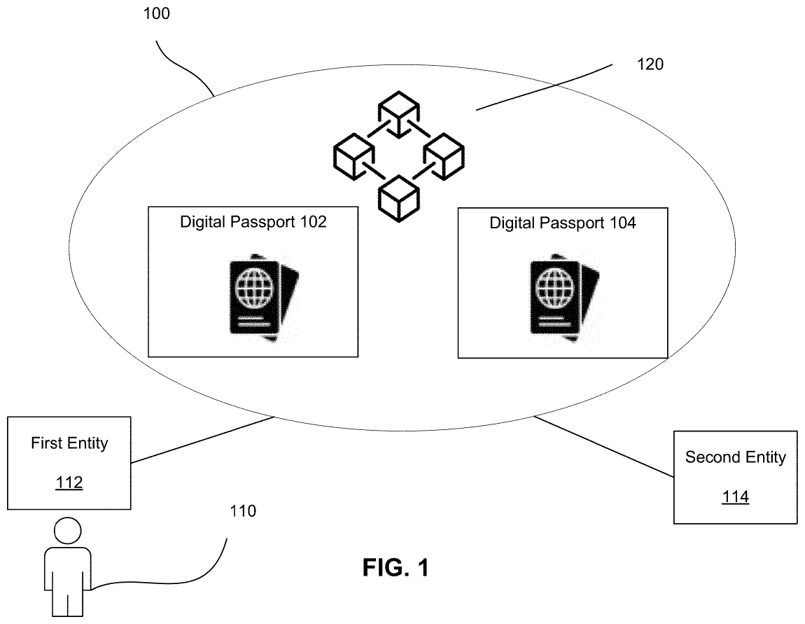

FIG. 1 depicts an environment of a system for managing verification and identity information, according to an embodiment of the present disclosure. In such an embodiment, the system 100 permits a user 110 associated with a first entity 112 to access a digital passport 102 associated with the first entity 112. The digital passport is populated based on publicly available information obtained from a public source, or private information submitted by the user. The information can be recorded in a blockchain 120. The system 100, according to this embodiment is configured to be accessible in a closed network or the internet. According to an embodiment, the user 110 adds authentication information to obtain possession of the digital passport 102, and to verify information about first entity 112 stored in the blockchain. In an embodiment, the user 110 accesses system 100 to obtain information from second entity 114 via a digital passport associated with second entity 114.

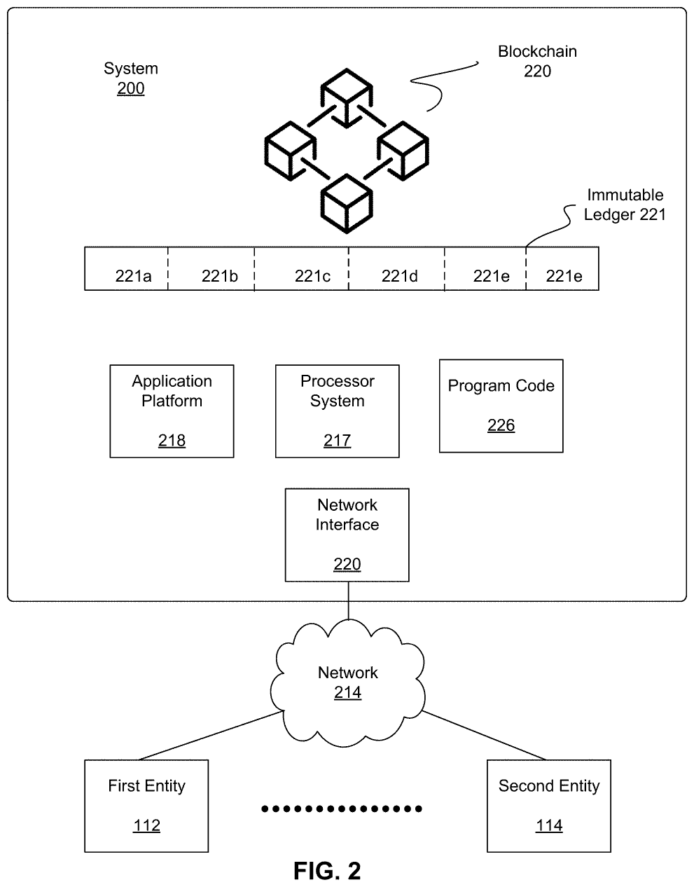

FIG. 2 is a schematic drawing of a system 200 for managing verification and identity information, according to an embodiment of the present disclosure. According to some embodiments, system 200 can include a private blockchain 220 formed and configured to be accessed by a user 110 associated with first entity 112 and another user associated with second entity 114. System 110 can be accessed via network 214, which may be a closed network, such as a virtual private network (VPN) or the internet.

Instructions stored in program code 226 stored in a memory and executed by processor system 217 can be operable to implement and manage private blockchain 220. Private blockchain 220 can be a distributed private blockchain and can include an immutable ledger layer 221 for recording transaction data. For example, private blockchain 120 can be configured to store and share blockchain records (e.g., blocks 221a to 221f) among a population of nodes. When a block is added to blockchain 220, system 200 is configured to communicate the addition through a network such that each node adds the block (e.g., blocks 221a to 221f) to its corresponding blockchain. Nodes of blockchain 220 periodically communicate (for example, once every minute, once every ten minutes, etc.) to confirm that blockchain 120 is accurately shared among nodes. Each block stored on blockchain 120 can include a cryptographic hash.

Application platform 218 provides a user interface permitting user 110 to access system 200. Accessing application platform 218 via network interface 220, user 110 associated with first entity 112 can provide attestation information to attest to his/her association with first entity 112 and obtain access to a digital passport 102. Access to the digital passport 102 can be restricted by application platform 218 of system 100 to the individual user 110. In this manner, a digital passport 102 permits a self-sovereign identity (SSI) relationship to user 110. Additionally, user 110 can request and receive access to another digital passport associated with second entity 114.

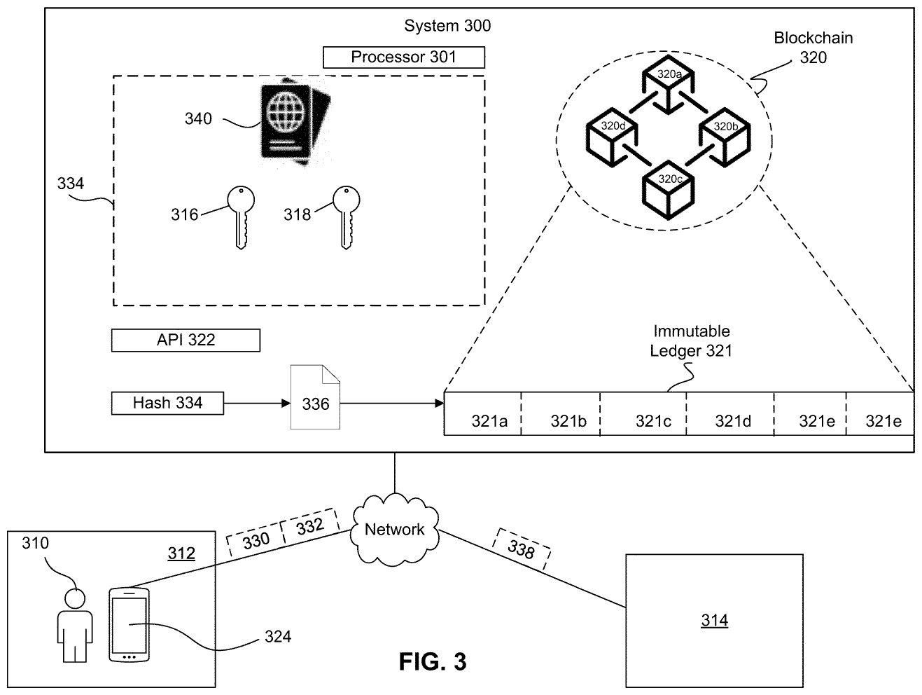

FIG. 3 is a schematic drawing of a system 100 for managing verification and identity information according to an embodiment of the present disclosure. According to such an embodiment, User 310 may be an individual associated with a first entity 312. In some non-limiting examples, first entity 312 may be a business or institution.

System 300 a processor 301 coupled to memory 302. System 300 can further include a private blockchain 320 formed and implemented by processor 301, the private blockchain 320 configured to be accessed by one or more of a user 310, an API 322 and a user interface 324 to acquire to information 330 about the first entity 312. User interface 324 can be displayed on a device controlled by user 310. Private blockchain 320 can be a distributed private blockchain and can include an immutable ledger layer 321 for recording transaction data. For example, private blockchain 320 can be configured to store and share blockchain records (e.g., blocks 321a to 321f) among a population of nodes 320a-d. When a block is added to blockchain 320, system 300 is configured to communicate the addition through network such that each node 320a-d adds the block (e.g., 321a to 321f) to its corresponding blockchain. Nodes 320a-d periodically communicate (for example, once every minute, once every ten minutes, etc.) to confirm that blockchain 320 is accurately shared among nodes 320a-d. Each block 321a to 321f stored on blockchain 320 can include a cryptographic hash.

According to some embodiments, system 300 enables a user to establish SSI and configures private blockchain 320 to adhere to Decentralized Identifiers (DID) standards, as described in detail below.

System 300 can receive first information 330 via API 322 or user interface 324. In some non-limiting examples, first information can be information that is retrieved by API 322 from publicly accessible sources. Alternatively, or additionally, first information can include information that not publicly available but that is transmitted to system 300 via the user interface 324. In some embodiments, system 300 is configured to enable user 310 to claim and edit first information 330 via user interface 324.

In response to receiving information 330, system 300 is configured to generate a first record 336 (i.e., block) comprising first information 330. First record 336 can be stored on immutable ledger layer 321. In some embodiments a cryptographic hash 334 can be generated by system 300 based on first information 330 and stored on immutable ledger layer 321 as first record 336. In some embodiments cryptographic hash 334 can be based on first information 330 and a time stamp.

Based on an input received via user interface 324, system 300 can generate a digital passport 340 for the first entity. Digital passport 340 can include an aggregation of shareable records (also referred to herein as “stamps”) associated with first entity 312, including first record 336.

User 310 can provide attestation information 332 that attests to the identity of user 310 associated with first entity 312. Access to digital passport 340 can be restricted by system 300 to the individual user 310. System 300 can generate a second record 338 comprising identity information associated with a first entity based on attestation information 332. In some embodiments a cryptographic hash 335 can be generated by system 300 based on attestation information 332 and stored on immutable ledger layer 321 as second record 337. Attestation information 332 can comprise information verifying that that the user is associated with first entity 312.

According to some embodiments, system 300 is configured to generate passport 340 that is associated with first entity 312 in response to receiving attestation information 332. In some embodiments, generating passport 340 includes generating at least one secure first key 316. First key 316 may be, for example, a public key or a private key. System 300 can be configured to provide user 310 access to secure key 316. In some embodiments system 300 generates second key 318 and provides user 310 access to second key 318. Like first key 316, second key 318 may be, for example, a public key or a private key. System 300 can be configured to associate first key 316 and second key 318 with passport 340 corresponding to first entity 312.

According to some embodiments, user 310 can submit a request (e.g., via user interface 324) to share or access a stamp with another entity. System 300 can be configured to generate a secure token 338 to provide sharing access of stamps between user 310 and another entity, such as a second entity 314. In response to the request, system 300 can transmit a secure communication of first key 316 from the digital passport 340 associated with user 310 to the second entity 314. Based on the request, second entity 314 can create an asset instance based on the first key 316. System 300 can share the asset instance with first entity 312, enabling user 310 to access the asset instance utilizing second key 318. In some embodiments, system 300 can send a transaction record associated with the asset on the immutable ledger 321 of the private blockchain 320.

According to some embodiments, system 300 enables user 310 to utilize passport 340 as a form of identification and payment to perform transactions with other entities.

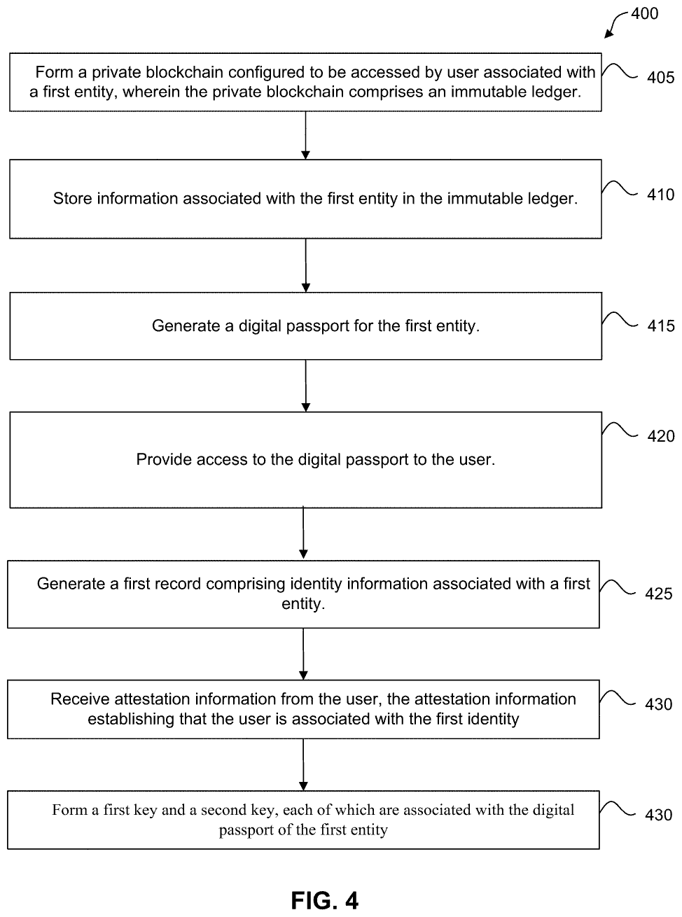

FIG. 4 is a flowchart of a method for a system for managing verification and identity information. According to an embodiment of the present disclosure, the method includes the steps of managing verification and identity information.

At operation 405, system 300 forms a private blockchain configured to be accessed by user associated with a first entity. As described above, the private blockchain comprises an immutable ledger. The private blockchain can be a distributed private blockchain and can include an immutable ledger layer (which can be an embodiment of immutable leger 221 or 321, for example) for recording transaction data. For example, private blockchain can be configured to store and share blockchain records among a population of nodes. Each added block can be communicated through a network such that each node of the blockchain adds the block to its corresponding blockchain. Operation 405 can include periodic verification that associated blockchains 220 are accurately shared among nodes.

At operation 410, system 300 stores information for the first entity on the private blockchain. Operation 410 can include generate a first record (e.g., record 336) comprising first information 330 and storing first record 336 on an immutable ledger layer (e.g., immutable ledger 321). In some embodiments a cryptographic hash 334 can be generated by system 300 based on first information 330 and stored on immutable ledger layer 321 as first record 336. In some embodiments cryptographic hash 334 can be based on first information 330 and a time stamp.

At operation 415, system 300 generates a digital passport (e.g., digital passport 340) for the first entity. In some embodiments, operation 415 can include generating digital passport 340 as an aggregation “stamps” associated with first entity 312, including first record 336. Stamps provided in digital passport 340 can include at least identity information, an employer identification number (EIN), know your business (KYB) information, know your customer (KYC) information, and credit information associated with the user 110 or the first entity 112.

At operation 420, system 300 provides access to the digital passport to the user. In some embodiments, operation 420 includes a user accessing system 300 and claiming ownership of a digital passport. Operation 420 can include placing restricted access to digital passport 340 permitting access (e.g., read and/or write access) only to the individual user 310. In some embodiments, operation 420 includes a user claiming ownership of the digital passport by scanning a QR code.

At operation 425, system 300 generates a first record comprising identity information associated with a first entity. In some embodiments, operation 425 includes the user adding one or more stamps representing authenticated identity and verification information to the digital passport. The stamps can be recorded as a first record in the immutable ledger. System 300 can enable a user to add multiple stamps to the digital passport associated with the first entity to augment or build a passport having higher verification value, and secure other proprietary information which the user may want to add to a directory entry associated with the first entity. In some embodiments, operation 425 includes adding one or more stamps comprising information about ownership of the first entity 112, identity information, an employer identification number (EIN), know your business (KYB) information, know your customer (KYC) information, and credit information associated with the user 110 or the first entity 112.

At operation 430, system 300 receives first attestation information from a user associated with the first entity. The attestation information establishes by verification that the user is associated with the first identity.

At operation 435, system 300 forms a first key and a second key, each of which are associated with the digital passport of the first entity. For example, the first key can be a public key and the second key can be a private key. Utilizing encryption keys, such as the first key and the second key, the first entity can be enabled to share data with a second entity. In some embodiments, system 300 can utilize a token validator, such as an Oracle Token Validator to ensure that the first and second keys are properly formed and initiated by the passport owner. In some embodiments, system 300 can generate additional keys to allow for read access of passport data.

For example, each user associated with an entity maintains and manages their passport keys to the blockchain (e.g., blockchain 320). The private key will either be stored in a secure element of a mobile device and/or secure location within the passport holder's systems. Generally, the private keys are not shared by the passport owner. According to some embodiments, system 300 can include a key management interface that will allow for user to recycle keys associated with the first entity.

At operation 435, when a user request to share an asset to another passport holder, user 110 can provide his/her public key to the second entity's (i.e., the asset owner's) passport. The second entity can then create an asset instance using the requesters public key and send a corresponding transaction record to the user via system 300, requesting passport identity. The asset instance can be marked in the blockchain 320 as a shared asset, such that it cannot be further shared by user 110. User 110 can then use their private key to open the asset via his/her digital passport. According to some embodiments, system 300 can include a token set to expire on the asset instance upon occurrence of some period or action. For example, a token can be set to expire at the occurrence of user 110 viewing the asset, to prevent multiple viewing. According to some embodiments, system 300 restricts sharing of an asset with a third party.

In some embodiments, the user can utilize the corresponding passport to gain access to other entities, such as second entity 114. In some embodiments, the user can utilize the corresponding passport as a form of identification and/or payment accepted by other entities, such as second entity 114. User 110 can provide permissions for second entity 114 to access one or more specific stamps required to perform a secure transaction.

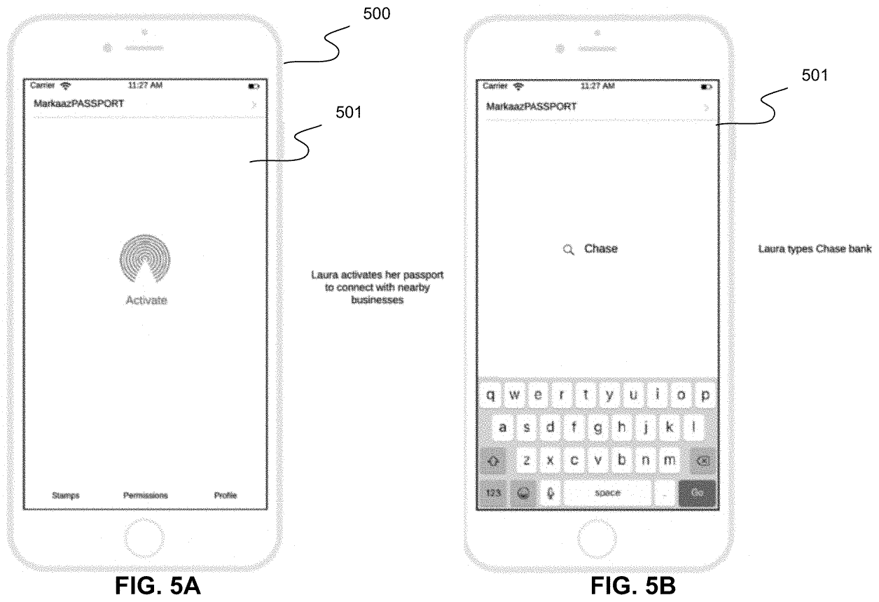

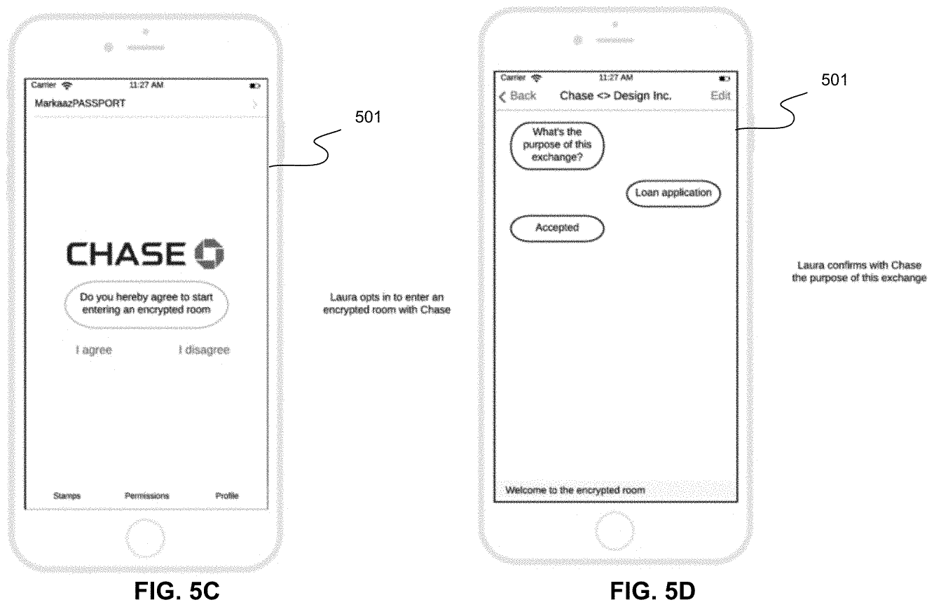

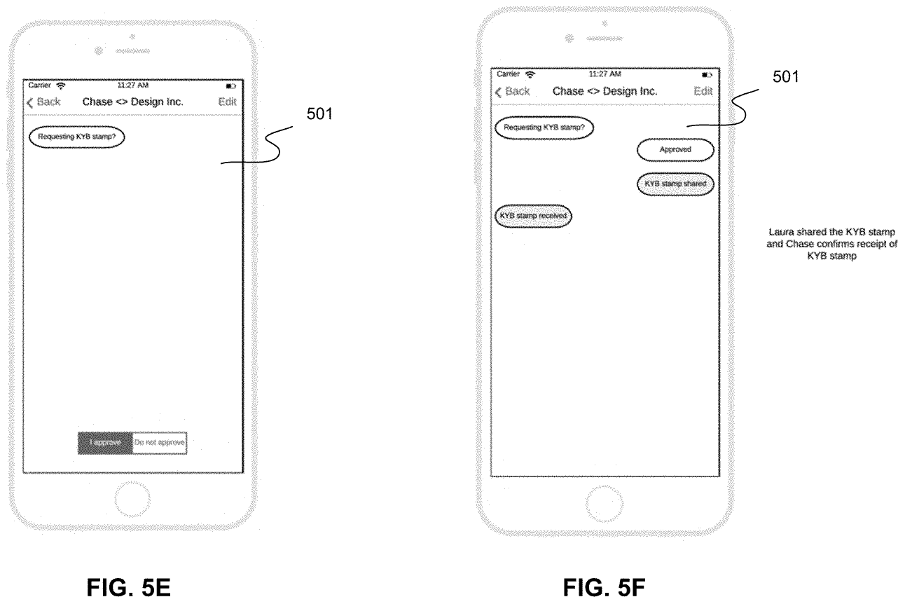

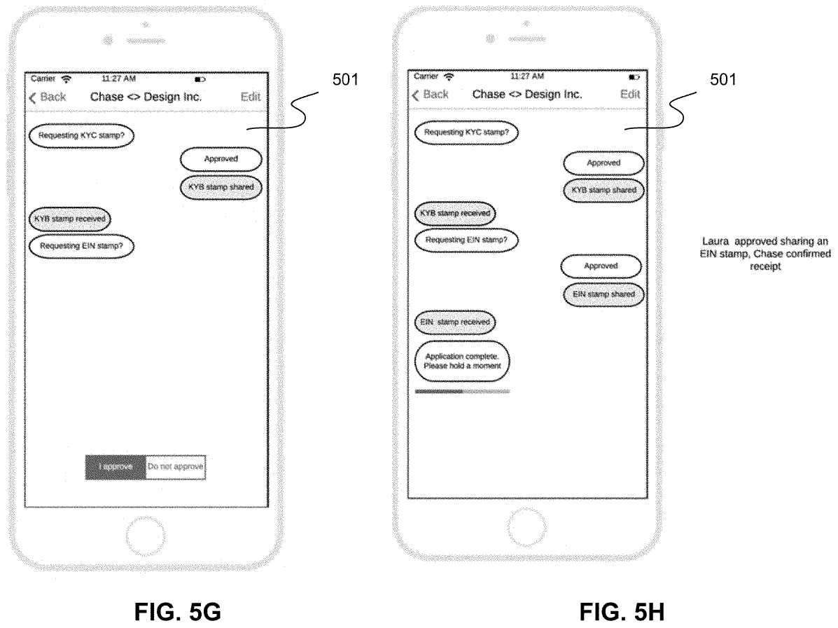

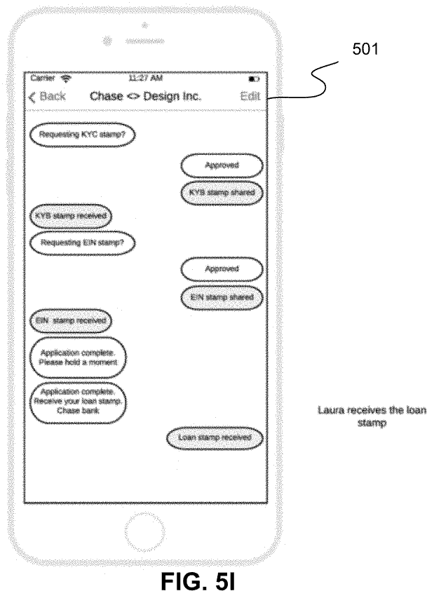

FIGS. 5A to 5D depict an exemplary user interface of mobile app 501 that connects a user to a system for managing verification and identity information. According to an embodiment of the present disclosure user interface 501 can operate on a mobile device 500 accessed by a user. In other embodiments (not shown), the user interface may be accessed on another computing device, such as a personal computer, table, personal digital assistant (PDA), etc.

In an exemplary use case, a user accesses the user interface hosted by a system host. The user can connect to a community of entities, such as businesses and institutions (e.g., creditors and other vendors of goods and services) via the system and user interface of mobile app 501.

In an example, the system compiles publicly available information about an entity associated with the user and stores a record of such information in a business directory. The user searches for and claims the record from the pre-populated directory. In some embodiments, the system provides a directory, search tools, or toolkits comprising a bundle of specialized tools to find an asset proposition. The user interface can include a dashboard of accessible tools or toolkits that provide access to other entities of the private community, and to request information about another entity authenticated by the system.

For example, an owner of a small business in Soho, NYC is looking to re-validate new and existing vendors following the collapse of the business'supply chain. The owner accesses system 100 via user interface 501 and claims a passport associated with his/her business. The owner accesses a variety of tools and toolkits, such as a know your customer (KYC) screening tool that provides due diligence customer screening for his own business.

The owner can access additional tools and toolkits, such as a relationship manager toolkit, that permits the owner to screen vendors and track any changes in their status. According to some embodiments, the owner can create alerts via the user interface to inform him/her of a change in the status of a vendor.

The owner can create a digital passport 102 to provide secure access to information about his business. The digital passport is configured to operate as a digital identity key that can be shared with and facilitate connecting with other entities among the community. In some embodiments, the owner can pay and be paid utilizing the digital passport 102.

The digital passport 102 digitizes information and stores it on blockchain 120, permitting the user to solely possess access to the digital passport, meaning you are the sole owner. Digital passport 102 includes one or more digital stamps giving you access to various entities and services. In the example use case, the Passport acts as a secure key for the owner to access one or more institutions that generally require verified business information before performing a transaction, such as when applying for credit, taking out a new lease, or verifying suppliers. The digital passport 102 collates and records digital stamps that allow incremental levels of identity verification. When the owner needs to perform a transaction, the institution can view passport 102, with the owner's permission and via a secure token, to access any necessary stamps to perform the transaction Further, because the information is pre-populated, verified and provided attestation by the owner, transaction verification can be performed immediately, with little or no additional time-requirements to performing due diligence.

As shown in FIG. 5A, a user (“Laura”) receives possession of and activates a digital passport associated an entity, e.g., her small design firm Design Inc. Utilizing a user interface of mobile app 501 Laura can populates her digital passport with stamps, including a KYB stamp, a KYC stamp, and an EIN stamp. The stamps include authenticated identity or verification information associated with Design Inc.

In the example shown in FIG. 5B, Laura can then utilize the digital passport via the user interface to search for another entity, such as a supplier or financial institution. In this example, Laura searches for a second entity, e.g., a financial institution (“Chase”), to request a loan for business or other financial needs associated with Design Inc.

As shown in FIG. 5C, user interface of mobile app 501 can be updated by a request from Chase to enter a secure, encrypted environment. Laura accepts the request utilizing the digital passport associated with Design Inc.

As shown in FIG. 5D, Laura can utilize the user interface of mobile app 501 to request a loan from Chase via Design Inc.'s passport, which contains a collection of authenticated stamps that will be required to secure financing.

As shown in FIG. 5E, to validate Laura's identity and information associated with Design Inc., Chase can request one or more stamps to be viewed from the digital passport of Design Inc., which is solely in the possession of Laura. User interface is populated with a message from Chase requesting to view a KYB stamp from Design Inc.'s digital passport.

In FIG. 5E, Laura shares a KYB stamp with Chase via her digital passport. A secure token is provided between the digital passport of Design Inc., and the digital passport of Chase, granting permission to access Design Inc.'s KYB stamp. As shown in FIGS. 5F to 5H, Chase may request viewing additional stamps stored in Design Inc.'s digital passport. Laura provides access utilizing a secure token communicated by system 300.

Following loan approval, Chase can transmit to Design Inc.'s digital passport a stamp corresponding to the approved transaction. In accordance with the new stamp, added by Chase, a block is added to the immutable ledger associated with Design Inc.'s passport creating a record of the loan approval, as shown in FIG. 5I.

Subsequently, a vendor that Design Inc. transacts business with, such as an equipment supplier, can request one or more stamps including the loan stamp received in FIG. 5I. The shop requests a stamp that proves I am liquid enough to have credit. That is verified via my bank and a third party.

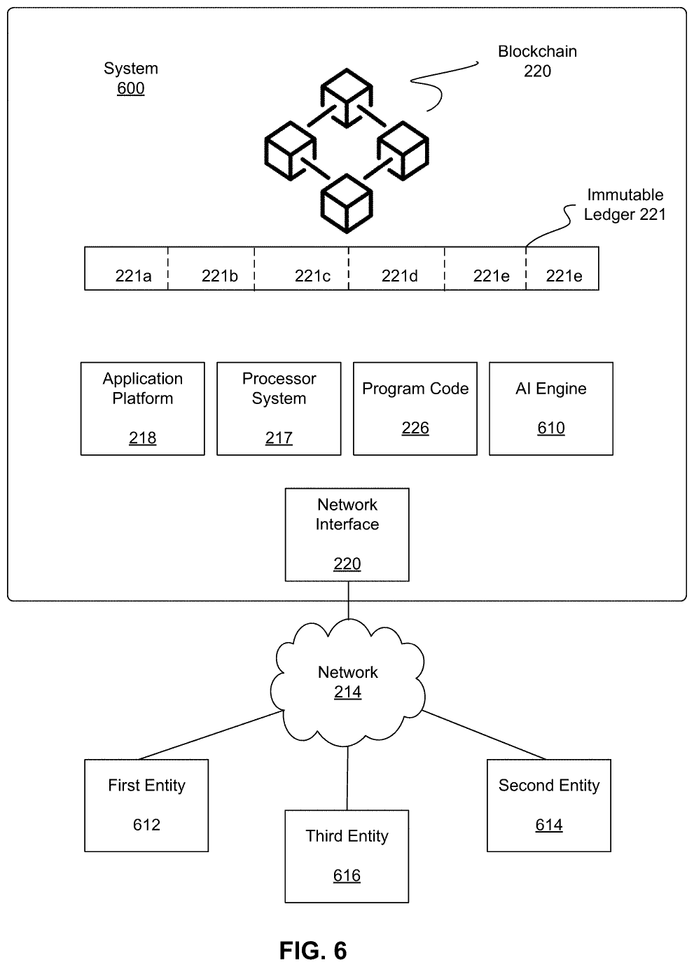

According to some embodiments, a system for managing entity identity information can include a platform to sell goods and services between users of the platform. For example, as shown in FIG. 6, a first entity 612 and a second entity 614 can use the platform to do business with each other and with other entities (e.g., third entity 616) via the platform. According to at least one embodiment, the system 600 can include an artificial intelligence (AI) engine 610 to identify entities as potential shoppers for a good or service offered for sale on the platform.

For example, one or more users associated respectively with first entity 612 and second entity 614 may elect to be put into groups (e.g., opt-in groups) for the purpose of receiving an offer for a good or service. A user associated with third entity 616 may submit information associated with an offer for a good or service via system 600. System 600 can then create one or more dynamic groups of users (e.g., users associated respectively with first entity 612 and second entity 614) based on (1) the information associated with the offer, (2) information associated with the entities (e.g., first and second entities 612 and 614), (3) information associated with the users, and any additional or other information.

In one non-limited example, system 600 includes AI engine 605 configured to determine which users may be interested in a current offer for a group purchase. Based on the determination, system 600 generates a dynamic group including such users to whom the offer is to be distributed. A dynamic group is temporary and is created ad-hoc for the purpose of receiving the group offer. Users have the option of declining the offer or agreeing to remain in the group and participate in the group purchase of the offer. By purchasing as a group, users in the dynamic group may receive a volume discount from the seller (e.g., third entity 616). The dynamic group is disbanded after the sale The users remain in the pool and may be assembled into future dynamic groups for future offers if the AI algorithm determines that they are likely interested in the new offer.

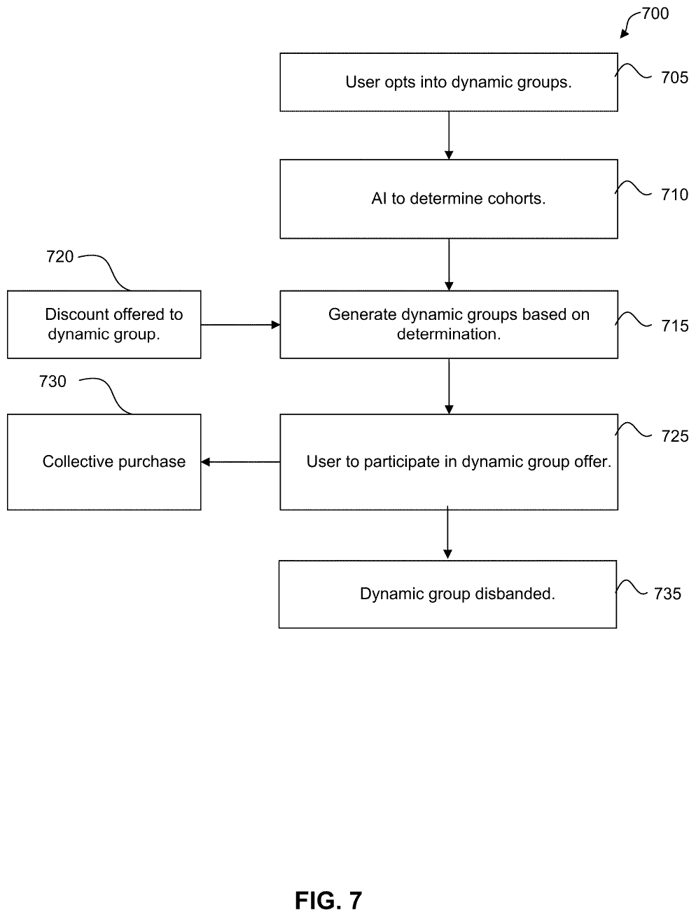

FIG. 7 is a flowchart of a method for generating a dynamic group. According to an embodiment of the present disclosure, the method includes utilizing an AI engine (e.g., AI engine 610) to populate one or more dynamic groups.

At operation 705, system 600 enables a user to opt into a participating in dynamic groups. For example, system 600 can include a user interface to receive a request from a user associated with an entity (e.g., first entity 612, second entity 614) allowing information associated with the user and/or entity to be utilized for the purpose of receiving offers for group purchases. As described above, the system can then create one or more dynamic groups of users (e.g., users associated respectively with first entity 612 and second entity 614) based on (1) the information associated with the offer, (2) information associated with the entities (e.g., first and second entities 612 and 614), (3) information associated with the users, and any additional or other information.

At operation 710, AI engine 605 determines cohorts (i.e., groups of users and/or entities) having characteristics suitable for grouping. According to some embodiments, AI engine 605 can use techniques for selecting potentially interested users, based on one or more of user demographics (e.g., type of business, size of business, location of business, etc.), past user purchases, past purchases by other similarly situated users, etc. In some embodiments, at 710 one or more records associated with users and/or associated entities is queried. In some embodiments, cohort analysis can be performed at 710 to identify potential group members.

At operation 715, system 600 generates a dynamic group based on the determination at operation 710. In some embodiments, system 600 can be configured to create a dynamic group having a predetermined size. In some embodiments, the size of the generated dynamic group is not limited. In some embodiments, a data record associated with one or more users can be modified to include information associated with the dynamic group.

At operation 720, an offer from a third party (e.g., third entity 616) is transmitted to dynamic group members. For example, as described above, an offer can include an offer for a group purchase that receives a bulk volume discount. In some embodiments, the offer can be transmitted by any manner including electronic means via the platform of system 600, such as a user interface thereof, or by email, postal mail, etc.

At operation 725, users can select whether to accept the offer. For example, a user can utilize the user interface of the platform to agree to the group purchase. According to some embodiments, a predetermined number of users may be required for the group purchase. In additional embodiments, the offer may be for a limited, predetermined time period to complete the sale.

At operation 730, a collective purchase can be made. In some embodiments, operation 730 can include waiting until a predetermined quantity of group members accepts the offer before proceeding with an associated transaction.

At operation 735, system 600 disbands the group. For example, the group can be disbanded after the group purchase has been completed or after the completion of the predetermined time period to complete the sale. According to some embodiments, information about the group can be retained in data of system 600 for further processing, AI training, etc.

### Granting Third Party Permissions

Within a digital identity, there are links to many assets. These assets are the discrete elements that we have collected as stamps. Such assets can include profile information, identity and verification information, such as a driver's license, credit report, etc. When a request for access is made for the assets, the owner will specifically grant access to only those specific assets. In some embodiments, this process will add the asset to the requesters identity as a shared asset controlled by the system to be viewed based on a nonce or time-based access key. The system can also be configurable to record the share and view actions on the asset contract directly, to facilitate auditability access to the asset.

### Encryption Keys/Handshake

Each user maintains and manages their passport keys to the blockchain. The private key will either be stored in a secure element of a mobile device and/or secure location within the passport holders systems. The private keys will not be shared. The system maintains a key management interface that will permits a passport holder to recycle their keys. When the user requests to share an asset to another passport holder, the requesting passport holder will provide their public key to the asset owner's passport. The assert owner's passport will then create an asset instance using the requester's public key and send the transaction record to the requesting passport. The asset instance is marked as a shared asset and cannot be further shared by requesting passport holders. The requesting passport will then use their private key to open the asset. According to some embodiments, a token expiration on the asset instance is configurable to prevent multiple viewing. The system is further configurable to disallow sharing of the asset beyond the requesting passport holder.

While this disclosure has been described as having various embodiments, these embodiments according to the present disclosure can be further modified within the scope and spirit of this disclosure. This application is therefore intended to cover any variations, uses, or adaptations of the disclosure using its general principles. For example, any methods disclosed herein represent one possible sequence of performing the steps thereof. A practitioner may determine in a particular implementation that a plurality of steps of one or more of the disclosed methods may be combinable, or that a different sequence of steps may be employed to accomplish the same results. Each such implementation falls within the scope of the present disclosure as disclosed herein and in the appended claims. Furthermore, this application is intended to cover such departures from the present disclosure as come within known or customary practice in the art to which this disclosure pertains.

What is claimed is:

1. A system for managing entity identity information, the system comprising:
a processor; and
a memory coupled with the processor, wherein the system is configurable to execute instructions via the processor to perform operations comprising:
forming a private blockchain configured to be accessed by a user associated with a first entity, wherein the private blockchain comprises an immutable ledger;
storing information for the first entity on the private blockchain;
generating a digital passport for the first entity;
providing access to the digital passport to the user;
generating a first record comprising identity information associated with a first entity;
receiving second attestation information from a user associated with the first entity, the first attestation information establishing verification that the user is associated with the first identity;
forming a first key and a second key, wherein the first key and the second key are associated with the digital passport of the first entity.

2. The system of claim 1, wherein the providing access to the digital passport is restricted by a host of the system to the user.

3. The system of claim 1, further comprising generating a stamp associated with the first entity in a record of the digital passport, wherein the stamp comprises information associated with the first entity.

4. The system of claim 3, wherein the stamp comprises information about one or more of: ownership information, identity information, an employer identification number (EIN), know your business (KYB) information, know your customer (KYC) information, and credit information.

5. The system of claim 1, the operations further comprising transmitting second attestation information to the user, the second attestation information comprise verification associated with a second entity, wherein the first entity is an asset requester and the second entity is an asset provider.

6. The system of claim 5, the operations further comprising
transmitting a secure communication of the first key from the user to the second entity;
creating an asset instance based on the public key;
sharing the asset instance with the first entity, wherein the user is enabled to access the asset instance based on the second key;
generating a transaction record associated with the asset on the immutable ledger of the private blockchain.

7. The system of claim 6, the operations further comprising sending the transaction record to the user.

8. A method, performed by a system of a system host, the system having at least a processor and a memory therein, the method comprising:
forming a private blockchain configured to be accessed by a user associated with a first entity, wherein the private blockchain comprises an immutable ledger;
storing information for the first entity on the private blockchain;
generating a digital passport for the first entity;
providing access to the digital passport to the user;
generating a first record comprising identity information associated with a first entity;
receiving attestation information from a user associated with the first entity, the attestation information establishing verification that the user is associated with the first identity;
forming a first key and a second key, wherein the first key and the second key are associated with the digital passport of the first entity.

9. The method of claim 8, wherein the providing access to the digital passport comprises restricting the access to the user.

10. The method of claim 8, further comprising storing a stamp associated with the first entity in a record of the digital passport, wherein the stamp comprises information associated with the first entity.

11. The method of claim 10, wherein the stamp comprises information about one or more of: ownership information, identity information, EIN information, KYB information, KYC information, and credit information.

12. The method of claim 8, further comprising transmitting second attestation information to the user, the second attestation information comprising verification information associated with a second entity, wherein the first entity is an asset requester and the second entity is an asset provider.

13. The method of claim 12, further comprising:
transmitting a secure communication of the first key from the user to the second entity;
creating an asset instance based on the public key;
sharing the asset instance with the first entity, wherein the user is enabled to access the asset instance based on the second key;
generating a transaction record associated with the asset on the immutable ledger of the private blockchain.

14. The method of claim 13, further comprising sending the transaction record to the user.

15. A non-transitory computer-readable storage medium having instructions stored thereupon that, when executed by a processor of a system having at least a processor and a memory cause the system to perform operations comprising:
forming a private blockchain configured to be accessed by a user associated with a first entity, wherein the private blockchain comprises an immutable ledger;
storing information for the first entity on the private blockchain;
generating a digital passport for the first entity;
providing access to the digital passport to the user;
generating a first record comprising identity information associated with a first entity;
receiving attestation information from a user associated with the first entity, the attestation information establishing verification that the user is associated with the first identity;
forming a first key and a second key, wherein the first key and the second key are associated with the digital passport of the first entity.

16. The non-transitory computer readable storage medium of claim 15, wherein the providing access to the digital passport comprises restricting the access to the user.

17. The non-transitory computer readable storage medium of claim 15, the operations further comprising storing a stamp associated with the first entity in a record of the digital passport, wherein the stamp comprises information associated with the first entity.

18. The non-transitory computer readable storage medium of claim 17, wherein the stamp comprises information about one or more of: ownership information, identity information, EIN information, KYB information, KYC information, and credit information.

19. The non-transitory computer readable storage medium of claim 15, the operations further comprising transmitting second attestation information to the user, the second attestation information comprising verification information associated with a second entity, wherein the first entity is an asset requester and the second entity is an asset provider.

20. The non-transitory computer readable storage medium of claim 15, the operations further comprising:
transmitting a secure communication of the first key from the user to the second entity;
creating an asset instance based on the public key;
sharing the asset instance with the first entity, wherein the user is enabled to access the asset instance based on the second key;
generating a transaction record associated with the asset on the immutable ledger of the private blockchain.
